(19) United States
(12) Patent Application Publication
(10) Pub. No.: US 2015/0178563 A1
(43) Pub. Date: Jun. 25, 2015

(54) DOCUMENT CLASSIFICATION

(71) Applicant: Carolina Galleguillos, San Diego, CA (US)

(72) Inventor: Carolina Galleguillos, San Diego, CA (US)

(73) Assignee: Hewlett-Packard Development Company, L.P., Houston, TX (US)

(21) Appl. No.: 14/414,529

(22) PCT Filed: Jul. 23, 2012
(86) PCT No.: PCT/US2012/047818

§ 371 Date: Jan. 13, 2015

(51) Int. Cl. G06K 9/00; G06F 17/30

(52) U.S. Cl. CPC G06K 9/00483; G06F 17/30011

(57) ABSTRACT

A system for document classification is disclosed herein. An example of the system includes a light source, a camera to capture video frames of the document, an image features database including data regarding a type of document, and a processor. The system additionally includes a non-transitory storage medium including instructions that, when executed by the processor, cause the processor to: compare a first video frame of the document and a second video frame of the document to determine whether an action has occurred, generate an image description of the document based upon either the first or second video frame, compare the image description of the document against the data regarding a type of document in the image features database, and classify the image description of the document based upon the comparison against the data. A method of document classification and a computer program are also disclosed herein.

### BACKGROUND

End-users appreciate ease of use and reliability in electronic devices. Automation of routine and/or mundane tasks is also desirable. Designers and manufacturers may, therefore, endeavor to create or build electronic devices directed toward one or more of these objectives.

### BRIEF DESCRIPTION OF THE DRAWINGS

The following detailed description references the drawings, wherein:

FIG. 1 is an example of a system for document classification.

FIG. 2 is an example of a flowchart for document classification.

FIG. 3 is an example of a method of document classification.

FIG. 4 is an example of an additional element of the method of document classification of FIG. 3.

### DETAILED DESCRIPTION

When capturing images of documents for electronic storage, it is useful to categorize such documents for later retrieval and use. This is particularly true as the number of such stored documents increases. Such categorization helps provide faster retrieval of a previously captured document, as well as other tasks, such as document collection management and editing.

The easier it is for an end-user to perform such document image capture and classification, the better. Several things can be done to accomplish this, such as providing a system, method, and computer program that automatically classifies documents subsequent to capture. Such a system, method, and computer program could provide a confidence level to the end-user regarding the certainty of such classification. This would alert the end-user to a possible issue with a particular document misclassification which could be corrected at the time of document image capture, which helps enhance the integrity and value of a collection of document images.

Allowing such document image capture and classification to occur under a variety of lighting conditions, natural and/or manmade, also increases the robustness and reliability of such a system, method, and computer program. For example, an end-user may begin work under sunny conditions which periodically turn shady due to intermittent clouds. As another example, an end-user may switch between different types of manmade lighting (e.g., incandescent and fluorescent) during different times of use of the system, method, and computer program.

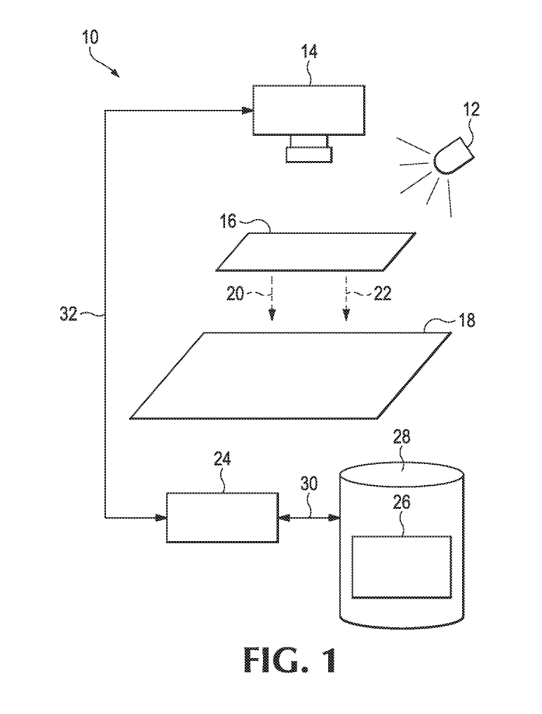

Allowing such document image capture and classification to occur through the use of a variety of different types of equipment and components additionally increases the effectiveness, accessibility, and versatility of such a system, method, and computer program. For example, allowing use of a variety of different types of cameras of varying levels of quality, features and cost. As another example, allowing the use of a variety of different computing devices from sophisticated mainframes and servers, as well as personal computers, laptop computers, and tablet computers. An example of such a system 10 for document classification is shown in FIG. 1.

As used herein, the terms “non-transitory storage medium” and non-transitory computer-readable storage medium” are defined as including, but not necessarily being limited to, any media that can contain, store, or maintain programs, information, and data. Non-transitory storage medium and non-transitory computer-readable storage medium may include any one of many physical media such as, for example, electronic, magnetic, optical, electromagnetic, or semiconductor media. More specific examples of suitable non-transitory storage medium and non-transitory computer-readable storage medium include, but are not limited to, a magnetic computer diskette such as floppy diskettes or hard drives, magnetic tape, a random access memory (RAM), a read-only memory (ROM), an erasable programmable read-only memory (EPROM), a flash drive, a compact disc (CD), or a digital video disk (DVD).

As used herein, the term “processor” is defined as including, but not necessarily being limited to, an instruction execution system such as a computer/processor based system, an Application Specific Integrated Circuit (ASIC), a computing device, or a hardware and/or software system that can fetch or obtain the logic from a non-transitory storage medium or a non-transitory computer-readable storage medium and execute the instructions contained therein. “Processor” can also include any controller, state-machine, microprocessor, cloud-based utility, service or feature, or any other analogue, digital and/or mechanical implementation thereof

As used herein, “camera” is defined as including, but not necessarily being limited to, a device that captures images in a digital (e.g., web-cam or video-cam) or analog (e.g., film) format. These images may be in color or black and white. As used herein, “video” is defined as including, but not necessarily being limited to, capturing, recording, processing, transmitting, and/or storing a sequence of images. As used herein, “video frame” is defined as including, but not necessarily being limited to, a video image.

As used herein, “document” is defined as including, but not necessarily being limited to, written, printed, or electronic matter, information, data, or items that provide information or convey expression. Examples of documents include text, one or more photos, a business card, a receipt, an invitation, etc. As used herein. “computer program” is defined as including, but not necessarily being limited to, instructions to perform a task with a processor. “Light source” and “lighting” are defined as including, but not necessarily being limited to, one or more sources of illumination of any wavelength and/or intensity that are natural (e.g., sunlight, daylight, etc.), man-made (e.g., incandescent, fluorescent, LED, etc.), or a combination thereof

Referring again to FIG. 1, system 10 includes a light source 12 and a camera 14 to capture video frames of a document 16. Document 16 is placed on a surface 18 by, for example, an end-user, as generally indicated by dashed arrows 20 and 22, so that such video frames may be captured. These captured video frames may be consecutive or non-consecutive depending upon the configuration of system 10 as well as the success of such capture, as discussed more fully below. Surface 18 may include any type of support for document 16 (e.g., desk, mat, table, stand, etc.) and includes at least one characteristic (e.g., color, texture, finish, shape, etc.) that allows it to be distinguished from document 16.

As can be seen in FIG. 1, system 10 additionally includes a processor 24 and an image features database 26 that includes data regarding one or more types of documents. As can additionally be seen in FIG. 1, system 10 additionally includes a non-transitory storage medium 28 that includes instructions (e.g., a computer program) that, when executed by processor 24, cause processor 24 to compare a first video frame of document 16 captured by camera 14 and a second video frame of document 16 captured by camera 14 to determine whether an action has occurred, as discussed more fully below.

Non-transitory storage medium 28 also includes additional instructions that, when executed by processor 24, cause processor 24 to generate an image description of document 16 based upon either the first or the second video frame, as well as to compare the image description of document 16 against data in image features database 26 regarding the type of document, as also discussed more fully below. Non-transitory storage medium 28 further includes instructions that, when executed by processor 24, cause processor 24 to classify the image description of document 16 based upon the comparison against the data regarding the type of document in image features database 26, as additionally discussed more fully below. Non-transitory storage medium 28 may include still further instructions that, when executed by processor 24, cause processor 24 to determine a confidence level for the classification of the image description of document 16, as further discussed below.

As can further be seen in FIG. 1, processor 24 is coupled to non-transitory storage medium 28, as generally indicated by double-headed arrow 30, to receive the above-described instructions, to receive and evaluate data from image features database 26, and to write or store data to non-transitory storage medium 28. Processor 24 is also coupled to camera 14, as generally indicated by double-headed arrow 32, to receive video frames of document 16 captured by camera 14 and to control operation of camera 14. Although image features database 26 is shown as being located on non-transitory storage medium 28 in FIG. 1, it is to be understood that in other examples of system 10, image features database 26 may be separate from non-transitory storage medium 28.

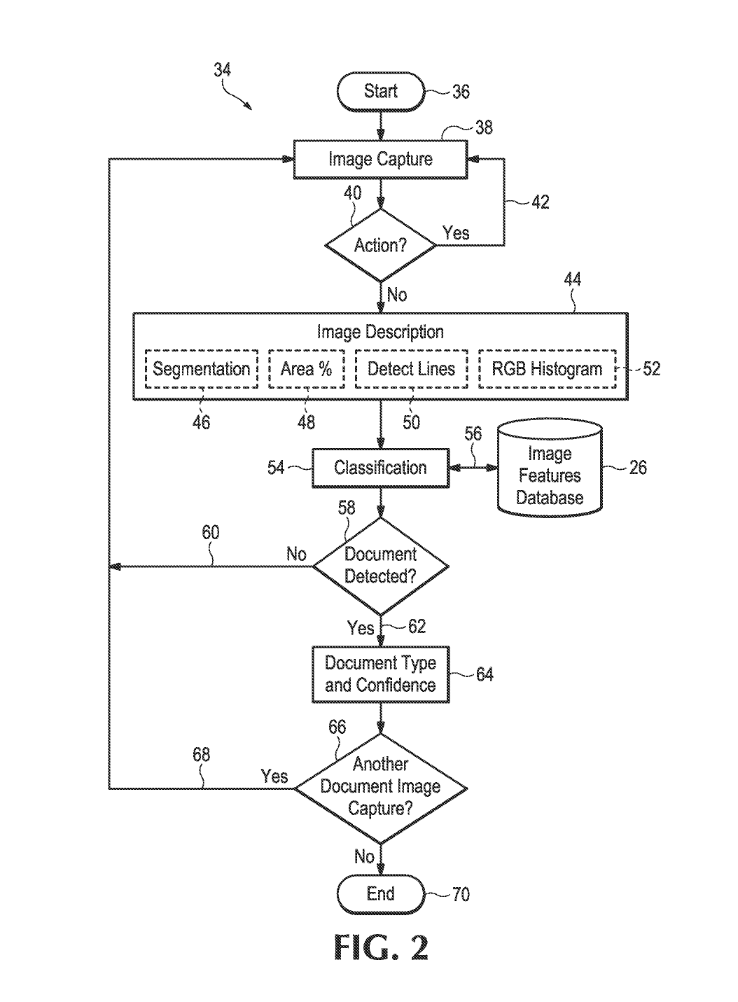

An example of a flowchart 34 for document classification via system 10 is shown in FIG. 2. The technique or material of flowchart 34 may also be implemented in a variety of other ways, such as a computer program or a method. As can be seen in FIG. 2, flowchart 34 starts 36 by capturing a first video frame image of document 16 via camera 14 and a second video frame image of document 16 via camera 14, as generally indicated by block 38. In this example, these images are represented in an RGB color space and have a size of 800×600 pixels. These images are passed to action recognition module 40 in order to determine whether an action has occurred. An action is occurring if document 16 is being placed on or being removed from surface 18. Otherwise, no action is occurring.

The difference between these video frame images is computed to determine whether an action as occurred. That is, the pixels in these video frame images are subtracted. If both frames are not the same, then an action is happening and new video frame images are captured as indicated by arrow 42 in FIG. 2. Variations in light are accounted for by not considering differences smaller than a predetermined amount (e.g., 300 pixels). If no action has occurred, then flowchart 34 proceeds to image description module or block 44.

As can be seen in this example shown in FIG. 2, image description module or block 44 includes four components: segmentation 46, document size or area percentage (%) 48, line detection 50, and color or RGB distribution 52. Segmentation component 46 involves locating the image of document 16 within one of the captured video frames and isolating it from any background components such as surface 18 which need to be removed.

Next image description 44 utilizes three different document characteristics: document size (α), number of text lines detected (β), and color distribution (h_{RGB}), as respectively represented by components 48, 50, and 52, to more accurately discriminate each document category. In this example, an image descriptor is constructed without utilizing any image enhancement or binarization, which saves computational time. This descriptor is a 50 dimensional feature (Dᵢ) that characterizes the document image and may represented as: Dᵢ=(α, β, h_{RGB}).

In this example, document size or area percentage (%) component 48 works by running Canny edge detection on the document image and then computing all boundaries. All the boundaries that are smaller to the mean boundary are discarded. After this, the convex hull is computed and then connected components are determined If the orientation of the region is not close to zero degrees (0°), then the image is rotated and the extent of the region is determined. The extent is determined by computing the area of the region divided by the corresponding boundary box. If the extent is less than 70%, it means that noisy regions have been considered as part of the document. This is the result of assuming that documents are rectangular objects.

These noisy regions are discarded by computing the convex hull of the objects in the image. If more than two (2) regions are present, then those regions which are furthest to the centroid of the biggest convex hull area and whose area is smaller than two (2) times the median are removed. Next, the biggest convex hull is computed and the boundary of this region is considered to be the segmentation of the document. The area of the document is then computed with respect to the size of the image frame.

In this example, line detection component 50 works by using image processing functions. Because the image resolution of document 16 may not be good enough to distinguish letters, text lines are estimated by locating salient regions that are arranged as substantially straight lines. Given an image, its edges may be located using Canny edge detection and then finding lines using a Hough transform. An assumption is made that document 16 is placed in a generally parallel orientation on surface 18 so only those lines with an orientation between 85 degrees and 115 degrees are considered. In order to consider the lines that may correspond to text, a Harris corner detector is also run on the image to obtain salient pixel locations. Lines that pass through more than three (3) salient pixels are considered to be text lines.

In this example, color or RGB distribution component 52 works by computing a 48-dimensional RGB color histogram of the region that contains document 16. Each histogram is the concatenation of three (3) 16 bit histograms, corresponding to the red (R), green (G), and blue (B) channels of the image.

As can also be seen in FIG. 2, classification module 54 is next executed or performed upon completion of image description module 44. Image features database 26 is utilized during this process, as generally indicated by double-headed arrow 56.

In this example illustrated in FIG. 2, a nearest neighbor classification method is used to classify document images. First, a set of m images corresponding to different documents are placed on surface 18 and captured individually. Each document class cᵢ, cᵢ ∈C has a similar number of image examples. Then, the 50 dimensional document descriptor Dᵢ, I=1 . . . m is computed for each image in the set in database 26. The resulting image features Dᵢ and labels cᵢ corresponding to each document class are then used once a new document image is classified.

To classify a document 16 never previously encountered, its respective document descriptor Dⱼ is computed. Then, the k-nearest neighbors of this descriptor in image features database 26 Dₘ is found using a chi-square distance function x(.). Finally the probability distribution over the labels for the document descriptor Dⱼ is computed using its k nearest neighbors η⊂Dₘ, weighted according to the number of examples per class:

P(C=c|Dⱼ)=Σx(Dⱼ, Dᵢ)/ωc; i∈η, cᵢ=c

Where cᵢ is the label of the descriptor Dᵢ in the database Dₘ and ω_{c} is the number of examples in class c. Finally, the document is classified with label cⱼ:

cⱼ=argmaxP(C=c|Dⱼ).

Referring again to FIG. 2, as block or module 58 of flowchart 34 illustrates, it is possible that the desktop area was empty or that a document may not have been detected at all. If this is the case, flowchart 34 returns to image capture block or module 38 to begin again, as generally indicated by arrow 60. If a document is detected, then the document type is presented to an end-user along with a confidence level for the document type classification, as generally indicated by arrow 62 and block or module 64. In this example, the confidence level is presented as a percentage (e.g., 80% positive of correct classification). If the end-user is unsatisfied with the particular presented confidence level, he or she may recapture images of the document by returning to block or module 38.

Flowchart 34 next proceeds to block or module 66 to determine whether there's another document image to capture. If there is, then flowchart 34 goes back to image capture module 38, as indicated by arrow 68. If these isn't, then flowchart 34 ends 70.

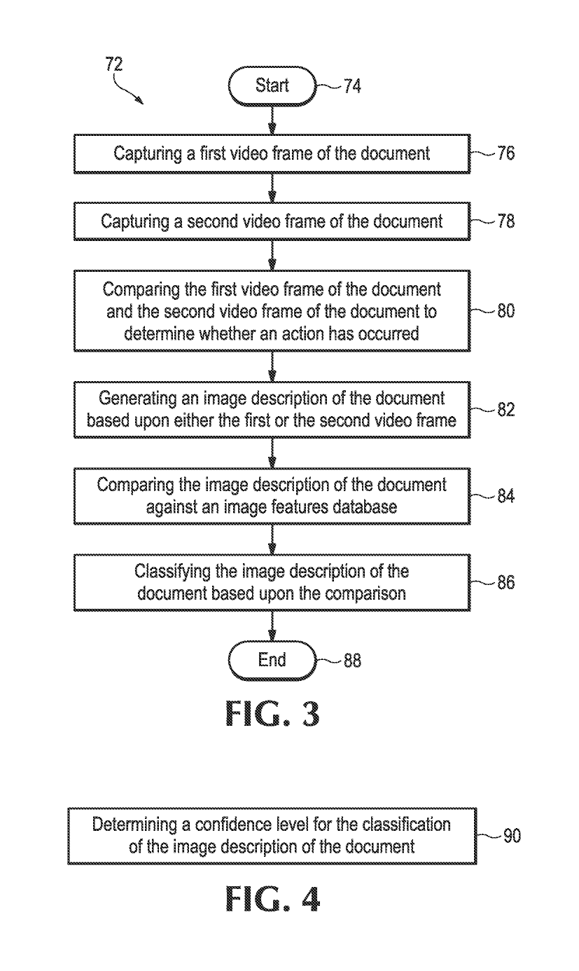

An example of a method 72 of document classification is shown in FIG. 3. As can be seen in FIG. 3, method 72 starts 74 by capturing a first video frame of the document, as indicated by block or module 76, and capturing a second video frame of the document, as indicated by block or module 78. Method 72 continues by comparing the first video frame of the document and the second video frame of the document to determine whether an action has occurred, as indicated by block or module 80, and generating an image description of the document based upon either the first or the second video frame, as indicated by block or module 82. Next, method 72 continues by comparing the image description of the document against an image features database, as indicated by block or module 84, and classifying the image description of the document based upon the comparison, as indicated by block or module 86. Method 72 may then end 88.

An example of an additional element of method 72 of document classification is shown in FIG. 4. As can be seen in FIG. 4, method 72 may further continue by determining a confidence level for the classification of the image description of the document, as indicated by block or module 90.

The capturing of the first video frame and the capturing the second video frame may occur under a different lighting. The element of generating an image description of the document 82 may include segmenting a document image from a background image. The element of generating an image description of the document 82 may also or alternatively include estimating an area of the document. The element of generating an image description of the document 82 may additionally or alternatively include estimating a number of lines of text in the document. The element of generating an image description of the document 82 may further or alternatively include describing a color distribution of the document. Finally, the document may include text, photos, a business card, a receipt, and/or an invitation.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art. The spirit and scope of the present invention are to be limited only by the terms of the following claims.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. A method of document classification, comprising:
capturing a first video frame of the document;
capturing a second video frame of the document;
comparing the first video frame of the document and the second video frame of the document to determine whether an action has occurred;
generating an image description of the document based upon one of the first and the second video frames;
comparing the image description of the document against an image features database; and
classifying the image description of the document based upon the comparison.

2. The method of document classification of claim 1, wherein the capturing of the first video frame and the capturing the second video frame occur under a different lighting.

3. The method of document classification of claim 1, further comprising determining a confidence level for the classification of the image description of the document.

4. The method of document classification of claim 1, wherein generating an image description of the document includes segmenting a document image from a background image.

5. The method of document classification of claim 1, wherein generating an image description of the document includes estimating an area of the document.

6. The method of document classification of claim 1, wherein generating an image description of the document includes estimating a number of lines of text in the document.

7. The method of document classification of claim 1, wherein generating an image description of the document includes describing a color distribution of the document.

8. The method of document classification of claim 1, wherein the document includes one of text, photos, a business card, a receipt, and an invitation.

9. A system for document classification, comprising:
a light source;
a camera to capture video frames of the document;
an image features database including data regarding a type of document;
a processor;
a non-transitory storage medium including instructions that, when executed by the processor, cause the processor to:
compare a first video frame of the document captured by the camera and a second video frame of the document captured by the camera to determine whether an action has occurred;
generate an image description of the document based upon one of the first and the second video frames;
compare the image description of the document against the data regarding a type of document in the image features database; and
classify the image description of the document based upon the comparison against the data regarding the type of document in the image features database.

10. The system of claim 9, wherein the light source has one of a variable intensity and a variable illumination.

11. The system of claim 9, wherein the non-transitory storage medium includes additional instructions that, when executed by the processor, cause the processor to determine a confidence level for the classification of the image description of the document.

12. The system of claim 9, wherein generating an image description of the image includes one of instructions to segment a document image from a background image, instructions to estimate an area of the document, instructions to estimate a number of lines of text in the document, and instructions to describe a color distribution of the document.

13. The system of claim 9, wherein the data regarding a type of document in the image features database includes data relating to one of text, photos, a business card, a receipt, and an invitation.

14. The system of claim 9, wherein the captured video frames are consecutive.

15. A computer program on a non-transitory storage medium, comprising:
instructions that when executed by a processor, cause the processor to capture a first video frame of a document;
instructions that when executed by a processor, cause the processor to capture a second video frame of the document;
instructions that when executed by a processor, cause the processor to compare the first video frame of the document and the second video frame of the document to determine whether an action has occurred;
instructions that when executed by a processor, cause the processor to generate an image description based upon one of the first and the second video frames;
instructions that when executed by a processor, cause the processor to compare the image description of the document against an image features database; and
instructions that when executed by a processor, cause the processor to classify the image description of the document based upon the comparison.

16. The computer program of claim 15, further comprising instructions that when executed by a processor, cause the processor to determine a confidence level for the classification of the image description of the document.

17. The computer program of claim 15, wherein the instructions that when executed by a processor, cause the processor to generate an image description of the document include instructions that segment a document image from a background image.

18. The computer program of claim 15, wherein the instructions that when executed by a processor, cause the processor to generate an image description of the document include instructions that estimate an area of the document.

19. The computer program of claim 15, wherein the instructions that when executed by a processor, cause the processor to generate an image description of the document include instructions that estimate a number of lines of text in the document.

20. The computer program of claim 15, wherein the instructions that when executed by a processor, cause the processor to generate an image description of the document include instructions that describe a color distribution of the document.

21. The computer program of claim 15, wherein the image includes one of text, photos, a business card, a receipt, and an invitation.
